(19) United States
(12) Patent Application Publication
(10) Pub. No.: US 2005/0169536 A1
(43) Pub. Date: Aug. 4, 2005

(54) System and method for applying active appearance models to image analysis

(76) Inventors: Vittorio Accomazzi, Toronto (CA); Diego Bordegari, Toronto (CA); Ellen Jan, Mississauga (CA); Peter Tate, Fergus (CA); Paul Geiger, Toronto (CA)

Correspondence Address: Ralph A. Dowell of DOWELL & DOWELL P.C., 2111 Eisenhower Ave., Suite 406, Alexandria, VA, 22314, US

(21) Appl. No.: 10/767,727

(22) Filed: Jan. 30, 2004

(51) Int. Cl. G06K 9/00; G06K 9/62; G06K 9/74

(52) U.S. Cl. 382/228; 382/128; 382/159

(57) ABSTRACT

An image processing system and method having a statistical appearance model for interpreting a digital image. The appearance model has at least one model parameter. The system and method comprises a two dimensional first model object including an associated first statistical relationship, the first model object configured for deforming to approximate a shape and texture of a two dimensional first target object in the digital image. Also included is a search module for selecting and applying the first model object to the image for generating a two dimensional first output object approximating the shape and texture of the first target object, the search module calculating a first error between the first output object and the first target object. Also included is an output module for providing data representing the first output object to an output. The processing system uses interpolation for improving image segmentation, as well as multiple models optimised for various target object configurations. Also included is a model labelling that is associated with model parameters, such that the labelling is attributed to solution images to aid in patient diagnosis.

The present invention relates generally to image analysis using statistical models.

### BACKGROUND OF THE INVENTION

Statistical models of shape and appearance are powerful tools for interpreting digital images. Deformable statistical models have been used in many areas, including face recognition, industrial inspection and medical image interpretation. Deformable models such as Active Shape Models and Active Appearance Models can be applied to images with complex and variable structure, including noisy and possible resolution difficulties. In general, the shape models match an object model to boundaries of a target object in the image, while the appearance models use model parameters to synthesize a complete image match using both shape and texture identify and reproduce the target object from the image.

Three dimensional statistical models of shape and appearance, such as that by Cootes et al. in the European Conference on Computer Vision entitled Active Appearance Models, have been applied to interpreting medical images, however, inter and intra personal variability present in biological structures can make image interpretation difficult. Many applications in medical image interpretation involve the need for an automated system having the capacity to handle image structure processing and analysis. Medical images typically have classes of objects that are not identical and therefore the deformable models need to maintain the essential characteristics of the class of objects they represent, but can also deform to fit a specified range of object examples. In general, the models should be capable of generating any valid target object of the object class the model object represents, both plausible and legal. However, current model systems do not verify the presence of the target objects in the image that are represented by the modelled object class. A further disadvantage of current model systems is that they do not identify the best model object to use for a specific image. For example, in the medical imaging application the requirement is to segment pathological anatomy. Pathological anatomy has significantly more variability than physiological anatomy. An important side effect in modeling all the variations of pathological anatomy in a representative model is that the model object can “learn” the wrong shape and as a consequence find a suboptimal solution. This can be caused by the fact that that during the model object generation there is a generalization step based on example training images, and the model object can learn example shapes that possibly do not exist in reality.

Other disadvantages with current model systems include uneven distribution in reproduced target objects of the image over space and/or time, and the lack of help in determining pathologies of target objects identified in the images.

It is an object of the present invention to provide a system and method of image interpretation by a deformable statistical model to obviate or mitigate at least some of the above presented disadvantages.

### SUMMARY OF THE INVENTION

According to the present invention there is provided n image processing system having a statistical appearance model for interpreting a digital image, the appearance model having at least one model parameter, the system comprising: a multi-dimensional first model object including an associated first statistical relationship and configured for deforming to approximate a shape and texture of a multi-dimensional target object in the digital image, and a multi-dimensional second model object including an associated second statistical relationship and configured for deforming to approximate the shape and texture of the target object in the digital image, the second model object having a shape and texture configuration different from the first model object; a search module for applying the first model object to the image for generating a multi-dimensional first output object approximating the shape and texture of the target object and calculating a first error between the first output object and the target object, and for applying the second model object to the image for generating a multi-dimensional second output object approximating the shape and texture of the target object and calculating a second error between the second output object and the target object; a selection module for comparing the first error with the second error such that one of the output objects with the least significant error is selected; and an output module for providing data representing the selected output object to an output.

According to a further aspect of the present invention there is provided an image processing system having a statistical appearance model for interpreting a sequence of digital images, the appearance model having at least one model parameter, the system comprising: a multi-dimensional model object including an associated statistical relationship, the model object configured for deforming to approximate a shape and texture of multi-dimensional target objects in the digital images; a search module for selecting and applying the model object to the images for generating a corresponding sequence of multi-dimensional output objects approximating the shape and texture of the target objects, the search module calculating an error between each of the output objects and the target objects; an interpolation module for recognising at least one invalid output object in the sequence of output objects, based on an expected predefined variation between adjacent ones of the output objects of the sequence, the invalid output object having an original model parameter; and an output module for providing data representing the sequence of output objects to an output.

According to a still further aspect of the present invention there is provided a method for interpreting a digital image with a statistical appearance model, the appearance model having at least one model parameter, the method comprising the steps of: providing a multi-dimensional first model object including an associated first statistical relationship and configured for deforming to approximate a shape and texture of a multi-dimensional target object in the digital image; providing a multi-dimensional second model object including an associated second statistical relationship and configured for deforming to approximate the shape and texture of the target object in the digital image, the second model object having a shape and texture configuration different from the first model object; applying the first model object to the image for generating a multi-dimensional first output object approximating the shape and texture of the target object; calculating a first error between the first output object and the target object; applying the second model object to the image for generating a multi-dimensional second output object approximating the shape and texture of the target object; calculating a second error between the second output object and the target object; comparing the first error with the second error such that one of the output objects with the least significant error is selected; and providing data representing the selected output object to an output.

According to a still further aspect of the present invention a computer program product for interpreting a digital image using a statistical appearance model, the appearance model having at least one model parameter, the computer program product comprising of a computer readable medium an object module stored on the computer readable medium configured for having a multi-dimensional first model object including an associated first statistical relationship and configured for deforming to approximate a shape and texture of a multi-dimensional target object in the digital image, and a multi-dimensional second model object including an associated second statistical relationship and configured for deforming to approximate the shape and texture of the target object in the digital image a search module stored on the computer readable medium for and applying the first model object to the image for generating a multi-dimensional first output object approximating the shape and texture of the target object and calculating a first error between the first output object and the target object, and for applying the second model object to the image for generating a multi-dimensional second output object approximating the shape and texture of the target object and calculating a second error between the second output object and the target object, the second model object having a shape and texture configuration different from the first model object a selection module coupled to the search module for comparing the first error with the second error such that one of the output objects with the least significant error is selected and an output module coupled to the selection module for providing data representing the selected output object to an output.

According to a still further aspect of the present invention a method for interpreting a digital image with a statistical appearance model, the appearance model having at least one model parameter, the method comprising the steps of: providing a multi-dimensional model object including an associated statistical relationship, the model object configured for deforming to approximate a shape and texture of multi-dimensional target objects in the digital images; applying the model object to the images for generating a corresponding sequence of multi-dimensional output objects approximating the shape and texture of the target objects; calculating an error between each of the output objects and the target objects; and recognising at least one invalid output object in the sequence of output objects, based on an expected predefined variation between adjacent ones of the output objects of the sequence, the invalid output object having an original model parameter; and providing data representing the sequence of output objects to an output.

### BRIEF DESCRIPTION OF THE DRAWINGS

These and other features of the preferred embodiments of the invention will become more apparent in the following detailed description in which reference is made to the appended drawings wherein:

FIG. 1 is a block diagram of an image processing system;

FIG. 2 is an example application of the system of FIG. 1;

FIG. 3a is an example of target object variability for the system of FIG. 1;

FIG. 3b is a further example of target object variability for the system of FIG. 1;

FIG. 4 is a block diagram of an image processing system for interpreting target object variability such as shown in FIGS. 3a and 3b;

FIG. 5 is an example operation of the multiple model AAM of FIG. 4;

FIG. 6 is an example set of training images of the system of FIG. 4;

FIG. 7 is a block diagram of an image processing system for interpreting target objects variability such as shown in FIG. 6;

FIG. 8 is an example operation of the system of FIG. 7;

FIG. 9 is an example definition of the model parameters of the system of FIG. 7;

FIG. 10 is an image processing system for interpolating model parameters for output objects as shown in FIG. 11;

FIG. 11 is an example implementation of the system of FIG. 10; and

FIG. 12 is an operation implementation of the system of FIG. 10.

### DESCRIPTION OF THE PREFERRED EMBODIMENTS

Image Processing System

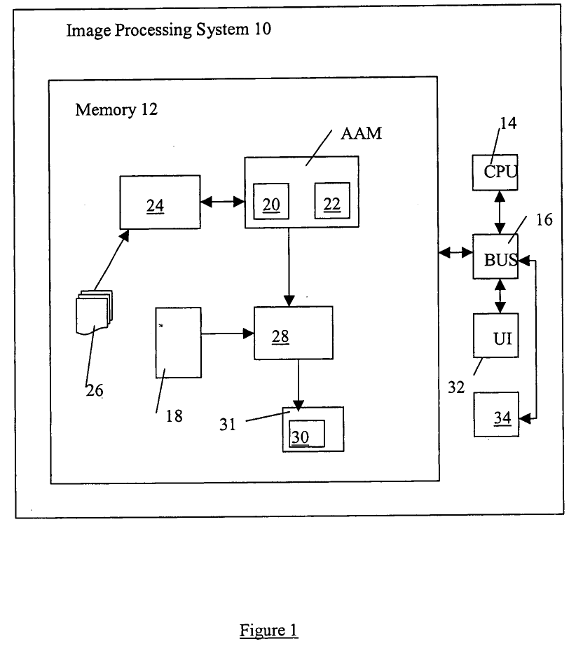

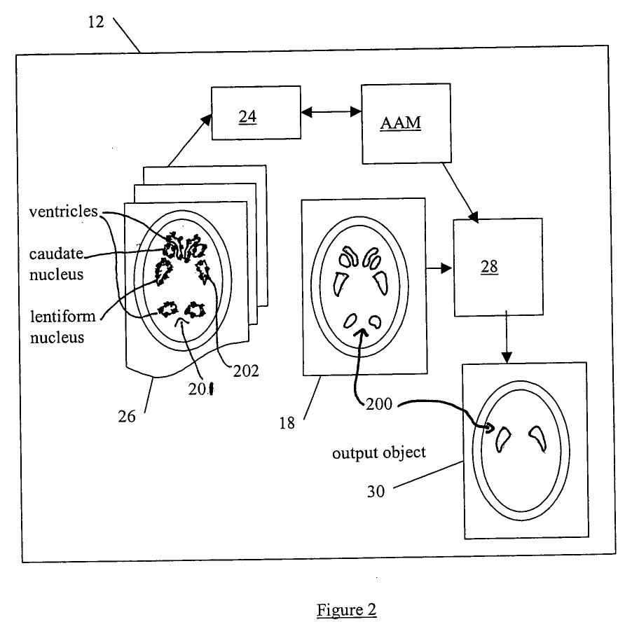

Referring to FIG. 1, an image processing computer system 10 has a memory 12 coupled to a processor 14 via a bus 16. The memory 12 has an active appearance model (AAM) that contains a statistical model object of the shape and grey-level appearance of a target object 200 (see FIG. 2) of interest contained in a digital image or set of digital images 18. The statistical model object of the AAM includes two main components, a parameterised 3D model 20 of object appearance (both shape and texture) and a statistical estimate of the relationship 22 between parameter displacements and induced image residuals, which can allow for full synthesis of shape and appearance of the target object 200 as further described below. It is recognized that the texture of the target object 200 refers to the image intensity or pixel values of individual pixels in the image 18 that comprise the target object 200.

The system 10 can use a training module 24 to determine the locally linear (for example) relationship 22 between the model parameter displacements and the residual errors, which is learnt during a training phase, to guide what are valid shape and intensity variations from a set of training images 26. The relationship 22 is incorporated as part of the model AAM. A search module 28 exploits during a search phase the determined relationship 22 of the AAM to help identify and reproduce the modeled target object 200 from the images 18. To match the target object 200 in the images 18, the module 28 measures residual errors and uses the AAM to predict changes to the current model parameters, as further described below, to produce by an output module 31 an output 30 representing a reproduction of the intended target object 200. Therefore, use of the AAM for image interpretation can be thought of as an optimisation problem in which the model parameters are selected which minimise the difference (error) between the synthetic model image of the AAM and the target object 200 searched in the image 18. It is recognized that the processing system 10 can also include only an executable version of the search module 28, the AAM and the images 18, such that the training module 24 and training images 26 were implemented previously to construct the components 20, 22 of the AAM used by the system 10.

Referring again to FIG. 1, the system 10 also has a user interface 32, coupled to the processor 14 via the bus 16, to interact with a user (not shown). The user interface 32 can include one or more user input devices such as but not limited to a QWERTY keyboard, a keypad, a trackwheel, a stylus, a mouse, a microphone and the user output device such as an LCD screen display and/or a speaker. If the screen is touch sensitive, then the display can also be used as the user input device as controlled by the processor 14. The user interface 32 is employed by the user of the system 10 to use the deformable model AAM to interpret the digital images 18 in order to reproduce the target object 200 as the output 30 on the user interface 32. The output 30 can be represented by a resultant output object image of the target object 200 displayed on the screen and/or saved as a file in the memory 12, as a set of descriptive data providing information associated with the resultant output object image of the target object 200, or a combination thereof. Further, it is recognized that the system 10 can include a computer readable storage medium 34 coupled to the processor 14 via the bus 16 for providing instructions to the processor 14 and/or to load/update the system 10 components of the modules 24, 28, the model AAM, and the images 18, 26 in the memory 12. The computer readable medium 34 can include hardware and/or software such as, by way of example only, magnetic disks, magnetic tape, optically readable medium such as CD/DVD ROMS, and memory cards. In each case, the computer readable medium 34 may take the form of a small disk, floppy diskette, cassette, hard disk drive, solid state memory card, or RAM provided in the memory 12. It should be noted that the above listed example computer readable mediums 34 can be used either alone or in combination. It is also recognized that the instructions to the processor 14 and/or to load/update components of the system 10 in the memory 12 can be provided over a network (not shown).

### EXAMPLE ACTIVE APPEARANCE MODEL ALGORITHM

Referring to FIGS. 1 and 2, in this section we describe how an example appearance model AAM can be generated and executed, as is known in the art. The approach can include normalisation and weighting steps, as well as sub sampling of points.

Training Phase

The statistical appearance model AAM contains models 20 of the shape and grey-level appearance of a training object 201, an example of the target object 200 of interest, which can ‘explain’ almost any valid example in terms of a compact set of model parameters. Typically the model AAM will have 50 or more parameters, such as but not limited to a shape and texture parameter C, a rotation parameter and a scale parameter. These parameters can be useful for higher level interpretation of the image 18. For example, when analysing face images the parameters may be used to characterise the identity, pose or expression of a target face. The model AAM is built based on the set of labelled training images 26, where key landmark points 202 are marked on each example training object 201. The marked examples are aligned to a common co-ordinate system and each can be represented by a vector x. Accordingly, the model AAM is generated by combining a model of shape variation with a model of the appearance variations in a shape-normalised frame. For instance, to build an anatomy model AAM, the training images 26 are marked with landmark points 202 at key positions to outline the main features of a brain, for example such as but not limited to ventricles, a caudate nucleus, and a lentiform nucleus (see FIG. 2).

The generation of the statistical model 20 of shape variation by the training module 24 is done by applying a principal component analysis (PCA) as is known in the art to the points 202. Any subsequent target object 200 can then be approximated using:
x=\overline{x}+Pₛbₛ (1)
where \overline{x} is the mean shape, Pₛ is a set of orthogonal modes of variation and bₛ is the set of shape parameters.

To build the statistical model 20 of the grey-level appearance, each example image is warped so that its control points 202 match the mean shape (such as by using a triangulation algorithm as is known in the art). The grey level information gᵢₘ is then sampled from the shape-normalised image over the region covered by the mean shape. To minimise the effect of global lighting variation, a scaling, α, and offset, β, can be applied to normalise the example samples
g=(gᵢₘ−β)/α (2)

The values of α and β are chosen to best match the vector to the normalised mean. Let \overline{g} be the mean of the normalised data, scaled and offset so that the sum of elements is zero and the variance of elements is unity. The values of α and β required to normalise gᵢₘ are then given by
a=gᵢₘ·\overline{g}, β=(gᵢₘ·1)/n (3)
where n is the number of elements in the vectors.

Of course, obtaining the mean of the normalised data is then a recursive process, as the normalisation is defined in terms of the mean. A stable solution can be found by using one of the examples as the first estimate of the mean, aligning the others to it (using equations 2 and 3), re-estimating the mean and iterating. By applying PCA to the normalised data we can obtain a linear model:
g=\overline{g}+P_{g}b_{g} (4)
where \overline{g} is the mean normalised grey-level vector, P_{g} is a set of orthogonal modes of variation and b_{g} is a set of grey-level parameters.

Accordingly, the shape and appearance models 20 of any example can thus be summarised by the vectors bₛ and b_{g}. Since there may be correlations between the shape and grey-level variations, we can apply a further PCA to the data as follows. For each example we can generate the concatenated vector

$$b = ( \frac{{W}_{s} {b}_{s}}{{b}_{g}} ) = ( \frac{{W}_{s} {P}_{s}^{T} ( x - \overline{x} )}{{P}_{g}^{T} ( g - \overline{g} )} ) \qquad ( 5 )$$

where Wₛ is a diagonal matrix of weights for each shape parameter, allowing for the difference in units between the shape and grey models (see below). We apply a PCA on these vectors, giving a further model
b=Qc
where Q are the eigenvectors and c is a vector of appearance parameters controlling both the shape and grey-levels of the model. Since the shape and grey-model parameters have zero mean, c does too. Note that the linear nature of the model allows us to express the shape and grey-levels directly as functions of c

$$\begin{matrix}x = \overline{x} + {P}_{s} {W}_{s} {Q}_{s} c , g = \overline{g} + {P}_{g} {Q}_{g} c \\ where & ( 7 ) \\ Q = ( \frac{{Q}_{s}}{{Q}_{g}} ) & ( 8 )\end{matrix}$$

It is recognized that Qs,Qg are matrices describing the modes of variation derived from the training image set 26 containing the training objects 201. The matrices are obtained by linear regression on random displacements from the true training set 26 positions and the induced image residuals.

Referring again to FIG. 1, during the training phase, the model AAM instance is randomly displaced by the training module 24 from the optimum position in the set of training images 26, such that the AAM learns the valid ranges of shape and intensity variation. The difference between the displaced model AAM instance and the image 26 is recorded, and linear regression is used to estimate the relationship 22 between this residual and the parameter displacement (i.e. between c and g). It is noted that the elements of bₛ have units of distance, those of b_{g} have units of intensity, so they cannot be compared directly. Because P_{g} has orthogonal columns, varying b_{g} by one unit moves g by one unit. To make bₛ and b_{g} commensurate, we estimate the effect of varying bₛ on the sample g. To do this we systematically displace each element of bₛ from its optimum value on each training example, and sample the image given the displaced shape. The RMS change in g per unit change in shape parameter bₛ gives the weight wₛ to be applied to that parameter in equation (5). The training phase allows the model AAM to determine the variance of each point 202, which provides for movement and magnitude intensity changes in each associated portion of the model object to assist in matching the deformable model object to the target object 200 in the image 18.

Using the above described example AAM algorithm, including the models 20 and relationship 22, an example output image 30 can be synthesised for a given c by generating the shape-free grey-level image from the vector g and warping it using the control points described by x.

Search Phase

Referring again to FIGS. 1 and 2, during the image search by the search module 28, the parameters are determined which minimise the difference between pixels of the target object 200 in the image 18 and synthesised model AAM model object, represented by the models 20 and relationship 22. It is assumed that the target object 200 is present in the image 18 with a certain shape and appearance somewhat different (deformed) from the model object represented by the models 20 and relationship 22. An initial estimate of the model object is placed in the image 18 and the current residuals are measured by comparing point by point 202. The relationship 22 is used to predict the changes to the current parameters which would lead to a better fit. The original formulation of the AAM manipulates the combined shape and grey-level parameters directly. An alternative approach would be to use image residuals to drive the shape parameters, and computing the grey-level parameters directly from the image 18 given the current shape. This approach can be useful when there are few shape modes and many grey-level modes.

Accordingly, the searching module 28 treats image 18 interpretation as an optimisation problem in which the difference between the image 18 under consideration and one synthesised by the appearance model AAM is minimised. Therefore, given a set of model parameters, c, the module 28 generates a hypothesis for the shape, x, and texture, gm, of a model AAM instance. To compare this hypothesis with the image, the module 28 uses the suggested shape of the model AAM to sample the image texture, gs, and compute the difference. Minimisation of the difference leads to convergence of the model AAM and results in generation of the output 30 by the search module 28.

It is recognised that the above described model AAM can also include such as but not limited to shape AAMs, Active Blobs, Morphable Models, and Direct Appearance Models as is known in the art. The term Active Appearance Model (AAM) is used to refer generically to the above mentioned class of linear and shape appearance models, and for greater certainty is not limited solely to the specific algorithm of the above described example model AAM. It is also recognised that the model AAM can use other than the above described linear relationship 22 between the error image and the additive increments to the shape and appearance parameters.

Variability in Target Objects

Referring to FIG. 1, current multi-dimensional AAM models do not verify for the presence of the target object 200 (see FIG. 2) in the image 18, which is properly representable by the specified multi-dimensional model object. In other words current multi-dimensional model AAM formulations find the best match of the specified multi-dimensional model object in the image 18, but do not check to see if the target object 200 modeled is actually present in the image 18. The identification of the best target model of the AAM to use for a specific image 18 has a significant implication in the medical imaging market. In the medical imaging application, the goal is to segment pathological anatomy. Pathological anatomy can have significantly more variability than physiological anatomy. An important side effect in modeling all the variations of pathological anatomy in one model object is that the model AAM can “learn” the wrong shape and as a consequence find a suboptimal solution. This improper learning during the learning phase can be caused by the fact that that during the model generation there is a generalization step based on the training example images 26.

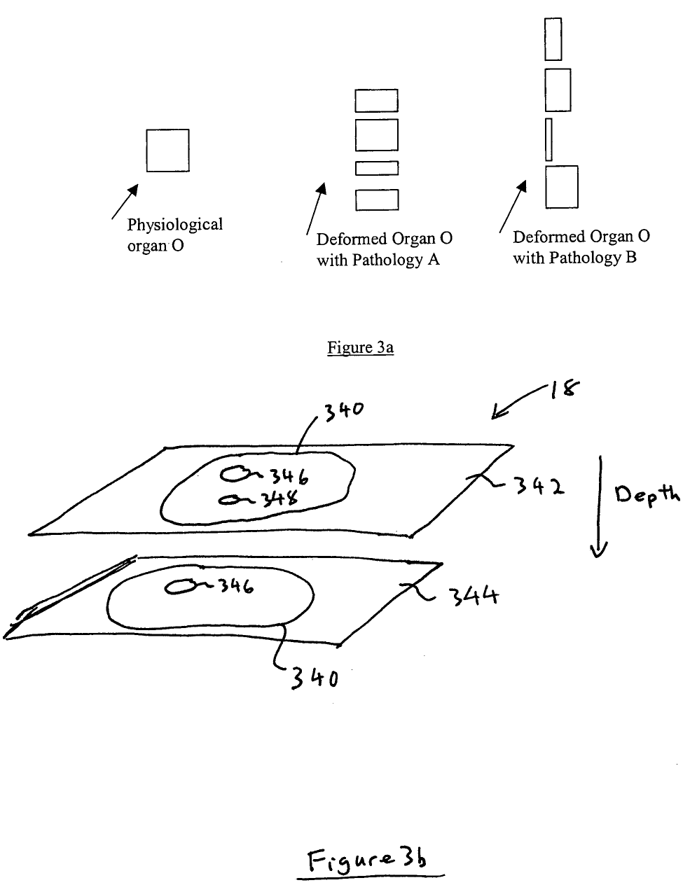

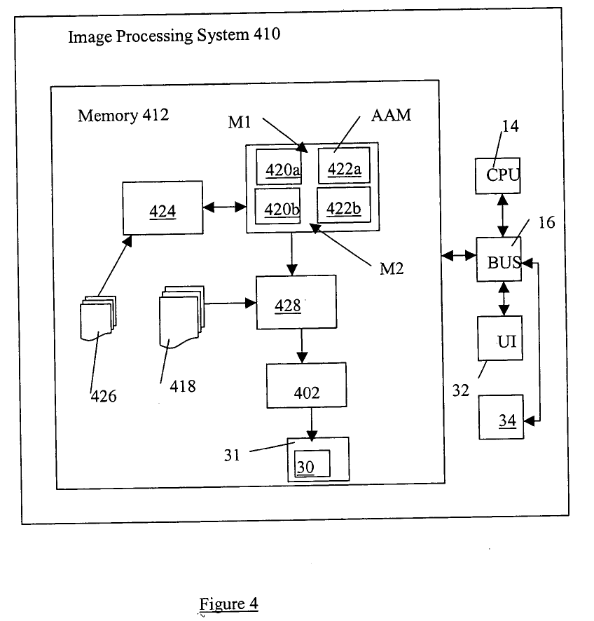

Referring to FIG. 3a, an example organ O has a physiological shape of a square with width and height set to 1 cm. Once the patient is affected with pathology A, the height of organ O can deform to be less then one, while if the patient is affected by pathology B, the width of the organ O can deform to can be less than one. In this example, it is noted that there is no valid pathology for having both the height and width of the organ O as both less than one simultaneously. It is recognised in this example that training example images 426 of FIG. 4 would not contain training models of the organ O having both the height and width of the organ O as both less than one simultaneously. Referring to FIG. 3b, an example is shown where the images 18 of FIG. 4 are represented as a set of 2D slices for representing a three dimensional volume of a brain 340 of a patient. Depending upon the depth of the individual image 18 slices, it can be seen that one slice 342 could contain both left 346 and right 348 ventricles, while a slice 344 could contain only one left ventricle 346. In view of the above, there are instances where the images 18 may contain significant variation in the target object such that one specified model object of the AAM would not result in a desired output 30, such as but not limited to a two ventricle model object being applied to the image 418 with only one ventricle present or a model object for pathology A being applied to the image 418 containing only an organ O with a pathology B. It is recognised that other examples of significant variation in target objects can exist over spatial and/or temporal dimensions(s).

Multiple Models

Referring to FIG. 4, like elements have similar reference numerals and description to those elements given in FIG. 1. An image processing computer system 410 has a memory 12 coupled to a processor 14 via a bus 16. The memory 12 has an active appearance model (AAM) that contains a plurality of statistical model objects, at least one of which is potentially appropriate for modelling the shape and grey-level appearance of a target object 200 (see FIG. 2) of interest contained in the digital image or set of digital images 418. Examples of the various model objects for heart applications are for such as but not limited to ventricles models, a caudate nucleus model, and a lentiform nucleus model, which can be used to identify and segment the respective anatomy from the composite heart image 418. The statistical 2D model objects of the AAM includes main components of parameterised 2D models 420a,b of object appearance (both shape and texture) and statistical estimates of the relationships 422a,b between parameter displacements and induced image residuals, which can allow for full synthesis of shape and appearance of the target object 200 as further described below. The components 420a,b, 422a,b are similar in content to those components 20, 22 described above, except that the model objects of the components 420a,b are 2D spatially rather than 3D model objects of the components 20 of the system 10 (see FIG. 1). Further, the components 420a, 422a of the model AAM of the system 410 represent one model object and associated statistical information, such as a model object for pathology A of the organ O of FIG. 3a and the components 420b, 422b for the pathology B of the organ O. Another example is where the components 420a, 422a represent the two ventricle geometry of the slice 342 of FIG. 3b and the components 420b, 422b represent the one ventricle geometry of the slice 344. It is recognized that the model AAM of the system 410 has two or more sets of 2D model objects (components 420a,b and 422a,b) representing predefined variability in target object 200 (see FIG. 2) configuration, such as but not limited to anatomy geometry associated with position within the image 418 volume and/or with varying pathology.

The system 410 can use a training module 424 to determine the multiple locally linear (for example) relationships 422a,b between the model parameter displacements and the residual errors, which is learnt during the training phase, to guide what are valid shape and intensity variations from appropriate sets of training images 26 containing various distinct configurations/geometries of the target object 200 as the training objects 201 (see FIG. 2). The relationships 422a,b are incorporated as part of the model AAM. Therefore, the training module 424 is used to generate the model AAM having the capability to apply multiple 2D model objects to the images 418. A search module 428 exploits during the search phase the determined relationships 422a,b of the AAM to help identify and reproduce the modeled target object 200 from the images 418. The search module 428 applies each of the 2D model objects (components 420a,b and 422a,b) to the images 418 in an effort to identify and synthesize the target object 200. To match the target object 200 in the images 418, the module 428 measures residual errors and uses the AAM to predict changes to the current model parameters to produce the output 30 representing the reproduction of the intended target object 200. It is recognized that the processing system 410 can also include only an executable version of the search module 428, the AAM and the images 418, such that the training module 424 and training images 426 were implemented previously to construct the components 420a,b, 422a,b of the AAM used by the system 410. The system 410 also uses a selection module 402 to select which of the applied 2D model objects by the search module 428 best represents the intended target object 200 (see FIG. 2).

Referring again to FIG. 4, in the general case we have the image set 418 and a set of 2D model objects M1 . . . Mn, which model a target object 200 (see FIG. 2) present in the image 418. The AAM algorithm of the system 410 can select which 2D model Mi best represents the target object 200 in the image 418. We present two example solutions to this problem, one which is generic, and the second which can require more information about the problem domain. Note that these solutions are not necessarily mutually exclusive.

General Solution

The general solution is to search for the target object 200 via the search module 428 with each model Mi in the image 418 and choose the output 30 with the most appropriate/smallest error computed as, for example, the difference of the output 30 image generated from the selected 2D model Mi and the target object 200 in the image 418. Note that the image 418, as described above with reference to the Example Active Appearance Model Algorithm, can be searched under a set of additional constraints (for example the model objects's spatial centre in the image 418 is within a specific region) and these constraints can be the same for all the models Mi, if desired. Therefore, two or more selected 2D models Mi are applied by the search module 428 to the image 418 in order to search for the target object 200. The selection module 402 analyses the error representing each respective fit between each Model Mi and the target object 200 and chooses the fit (output 30) with the lowest error for subsequent display on the interface 32.

Also note that several error measures have been proposed for measuring the difference between the image output 30 generated by the model Mi, and output by the module 31, and the actual image 418. For example Stegmann proposed the L2 norm, Mahalanobis, and Lorentzian metrics as error measure. Any of these measures are valid for our invention including the average error which provide adequate results according to our tests:

$$AverageError = \frac{{\sum }_{( i , j ) where Model is Defined} \vert Model ( i , j ) - Image ( i , j ) \vert}{ModelSamples} ,$$

where ModelSamples is the number of samples defined in the model Mi. The AverageError seems to have a value which is relatively independent of the model Mi used (in the Mahalanobis distance each sample's difference with the image is weighed with the sample's variance). It is recognised that the AverageError produced by application each of the selected models Mi, from the plurality of models Mi of the AAM, to the image 418 can be normalised to aid in choice of the model Mi with the best fit of the target object 200, in cases where each of the models Mi are constructed with a different number of points 202 (see FIG. 2).
Specific Solution Example

A second approach is based on the selection of the models Mi, or sets of models Mi, to use based on the presence of other predefined objects in the image 418 and/or the relative position of other organs in the image 418 to other images 418 of the patient. For example, in the analysis of the heart if dead tissues have been found, tipically from a different exam or based on the patient's history, in any image inside the myocardium of the patient (as a result of an infract), then the algorithm of the search module 428 will select the “Myocardio Infracted Model” for the identification of the heart on the image 418, rather then normal physiological model Mi of the heart. The same idea can be applied on simpler situation, such as we can select the model Mi based on age or sex of the patient. It is recognised in the example that during the training phase, various labels can be associated with the target objects 200 in the training images 426, for representing predefined pathologies and/or anatomy geometries. These labels would also be associated with the respective models Mi representing the various predefined pathologies/geometries.

It is noted that a potential benefit to selecting the best model Mi for segmentation of an organ (target object 200) on a specific image 418 is not limited to an improvement of the segmentation. The selection of the model Mi can actually provide valuable information on the pathology that is present in the patient. For example, in FIG. 3a the selection of the model A, rather than the model B indicates that the patient having Organ 0 as identified in the output 30 represents a potential diagnosis of pathology A, as further described below.

Operation of Multiple Model AAM

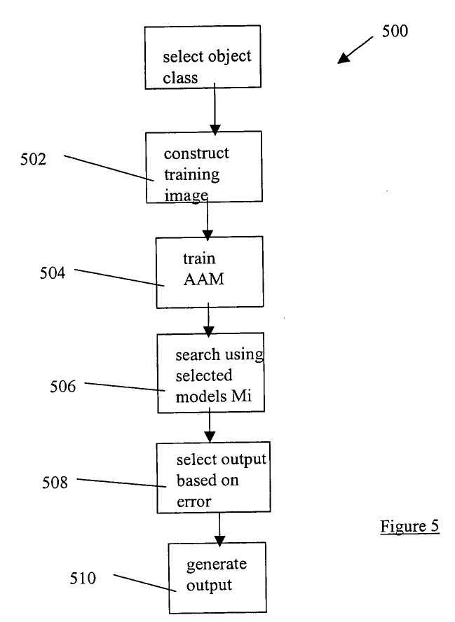

Referring to FIGS. 4 and 5, operation 500 of the multiple 2D models Mi of the AAM algorithm is as follows. The intended target object class is selected 502 by the system 410 based on anatomy selected for segmentation. A plurality of training images 426 are made 504 representing multiple forms of the target object class, i.e. containing various distinct configurations/geometries of the target object 200 (see FIG. 2). The training module 424 is used to determine 506 the multiple relationships 422a,b between the model parameter displacements and the residual errors for each of the models 420a,b, to guide what are valid shape and intensity variations from the set of training images 426. A plurality of models Mi are then included in the AAM by the training moduel 424. The search module 428 exploits 508 during the search phase selected models Mi of the AAM to help identify and reproduce the modeled target object 200 from the images 418, wherein two or more selected 2D models Mi are applied by the search module 428 to the image 418 in order to search for the target object 200. The selection module 402 analyses 510 the error representing each respective fit between each selected 2D model Mi and the target object 200 of the image 418 and chooses the fit (output 30) with the lowest error. The output 30 is then displayed 512 on the interface 32 by the output module 31. It is recognised that steps 502, 504, and 506 can be completed in a separate session (training phase) from application of the AAM (search phase). It is recognised that step 508 can also include the use of addditional information, such as model Mi labels, to aid in the selection of the models Mi to apply to the images 418.

Another variation of the multiple model method described above is where we want to find the best model object Mi across the set of models M1 . . . Mn, in order to segment a set of images 418 (i.e. I1 . . . In). The images 418 are such, as described in “AAM Interpolation described below”, wherein the same anatomy images 418 are selected over time for the same spatial location (i.e. a temporal image sequence). There are two algorithms that we can use for applying the set of model objects M1 . . . Mn to the set of images I1 . . . In, such as but not limited to “minimum error criteria” and “most used model” as further described below.

Minimum Error Criteria

Each Model object Mi is applied to each Image Ii of the set of images 418. All the error in the segmentation of the set of images I1 . . . In for each of the model objects Mi are summed up and the one applied model object Mi with the deemed least significant error is selected. The error in the segmentation of the set of images Ii . . . In, for a given model object Mi, is considered the sum of the error for each image Ii in the set of images 418 (overall average error can work as well, since they differ only by a scale factor). Once one model object Mi is chosen, the output objects 30 related to the selected model object Mi are then used to aid in segmentation of the set of images 418.

Most Used Model

For each Model Mi we keep a “frequency of use” score Si. For each image Ii in the set of images I1 . . . In we segment the image Ii with all the model objects M1 . . . Mn. We then increment the score Si of each of the model objects Mi with the lowest error for each of the respective images Ii. The system 410 then returns the model object Mi with the maximum score Si, which represents the model object Mi that most frequently resulted in the lowest error for the images Ii of the image set I1 . . . In. So in other terms we select the model object Mi which has been chosen for most of the images Ii of the set, based on for example the minimum error criteria. In this case, the model object Mi which resulted in being selected most often on an image Ii by image Ii basis from the set is chosen as the model object Mi to provide the sequence of output objects 30 for all images Ii in the image set.

Mixed Model

It is also recognized that for the set of images I1 . . . In represented by a spatial image sequence (images Ii distributed over space), different model objects Mi can be used to provide corresponding output objects 30 for selected subsets of the total image set I1 . . . In. Each of the model objects Mi selected for a given subset of images can be based on a minimum error criteria, thereby matching the respective model object Mi with the respective image(s) I1 . . . In that resulted in a least error for the respective images I1. In other words, more than one model object Mi can be used to represent one or more respective images from the image set I1 . . . In.

Model Labeling

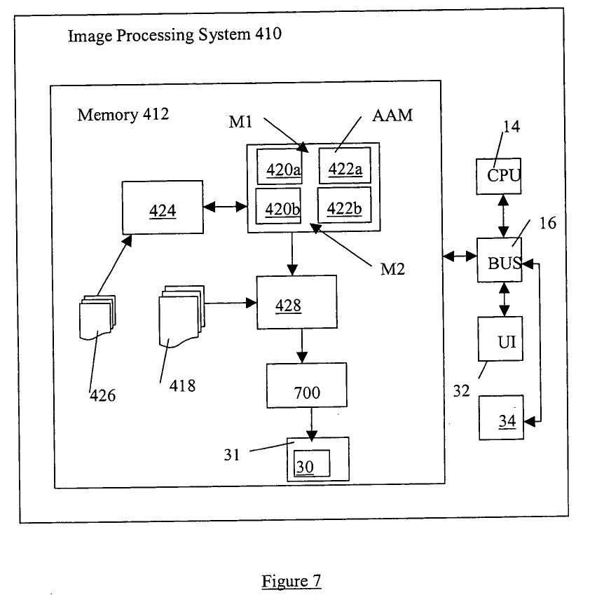

Referring to FIG. 7, like elements have similar reference numerals and description to those elements given in FIG. 4. The system 410 also has a confirmation module 700 for determining the value of a model parameter of the AAM assigned to the output object 30. The training module 424 is used to add a predefined characteristic label to the model parameters, such that the label is indicative of a known condition of the associated target object 200 (see FIG. 2), as further described below. The model parameters are partitioned into a number of value regions, such that different predefined characteristics indicating a known condition are assigned to each of the regions. The representative model parameter values for each predefined characteristic are assigned to various target objects 200 in the training images 426 and are therefore learnt by the AAM model during the training phase (described above). The value of the model parameter is indicative of a predefined characteristic of the target object 200 (see FIG. 2), which can aid in the diagnosis of a related pathology as further described below.

In the previous section we described how multiple models 420a,b, 422a,b can be used to help improve the identification of the target object 200 and ultimately to help improve segmentation of this identified target object 200 from the image 418 (see FIG. 4). The model AAM can also be used to help determine additional information on the organ segmented (such as the pathology) in the form of predefined characteristics associated with discrete value regions of the model parameter.

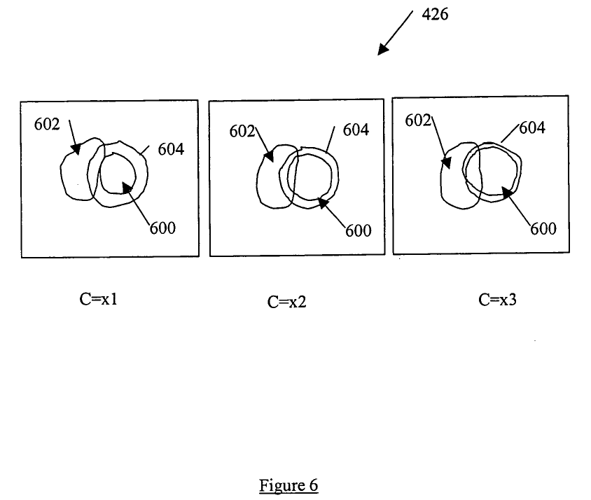

Referring to FIGS. 2 and 6, we note that the AAM model is able to generate a near realistic image of the searched target object 200 (a ventricle 600 in our example) based on the Model Parameters C, Size and Angle. The position locates the target object in the image 418, such that the output object 30 of AAM model of a heart is associated with different Model Parameters C=x1, x2, x3. It is noted that the values x1, x2, and x3 are the converged C values assigned to the output object 30 by the search mondule 428 as best representing the target object in the image 418. The images 426 of FIG. 6 show example target objects of a left ventricle 602, the right ventricle 600 and a right ventricle wall 604. We note that the Model Parameter C is the one which actually determines the shape and the texture of the output object 30. For example, C=x1 can represent a thick walled right ventricle 600, C=x2 can represent a normal walled right ventricle 600, and C=x3 can represent a thin walled right ventricle 600. It is recognised that other model parameters can be used, if desired.

Labelling Operation

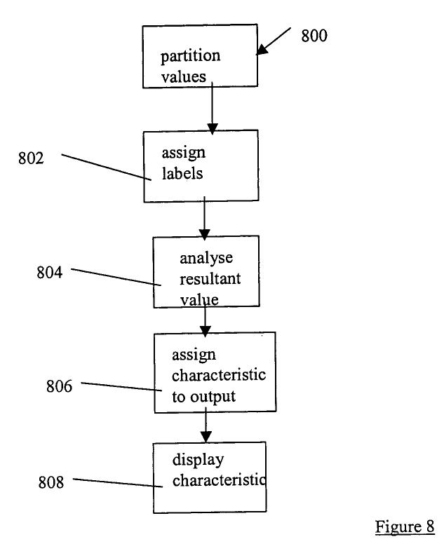

Referring to FIG. 8, the AAM model has partitioned 800 the parameter C into “n” regions such that in each region the AAM model presents a specific predefined characteristic. The regions will then be labeled 802 with that characteristic by, for example, a cardiologist, who types in text for characteristic labels associated with specific contours of the various training objects in the training images 426. Once the search is completed by the search module 428, the Model Parameter C associated with the output object 30 of the search is used to identify 804 by the confirmation module 700 the region to which the parameter value belongs, and so assign 806 the predefined characteristic for the patient having the ventricle 604 modelled by the output object 30. Data representing the output object 30 as well as the predefined characteristic is then provided 808 to the output by the output module 31. It is recognised that various functions of the modules 428, 31, and 700 can be configured other than described, for example the search module 428 can generate the output object 30 and then assign the predefined characteristic based on the value of the associated model parameter.

Example Parameter Assignment

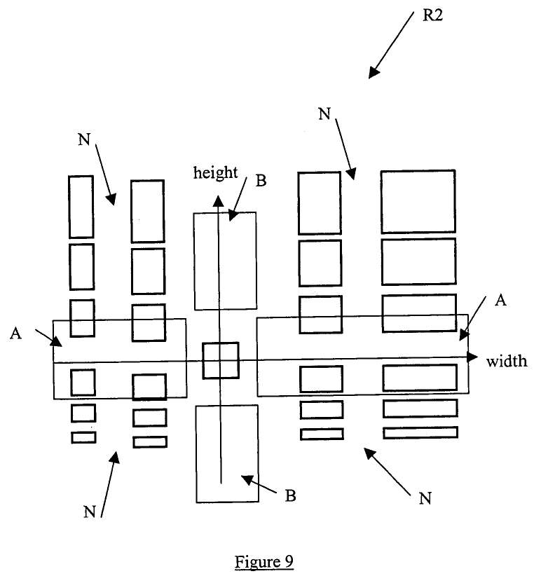

Let us consider an example. Consider the sample organ O in FIG. 3a. We build the AAM model with all the valid training images 426 (see FIG. 4) and we keep 2 components for the definition of the parameter vector C (ie we keep two eigenvector). So the C space is actually R2. In such space each point represent a value for C and so a shape and texture in the AAM Model. We can graphically represent the location of the model in the plane R2 as in FIG. 9. The average shape (at the origin) of the organ O is the square. The horizontal axis represents change in the width of the organ O and the vertical axis represents the change in the height. As you can notice in this plane R2 all the shapes that represent pathology A (height less than 1) are close together and all the shapes that present pathology B (width less than one) are close together. So we can generate two regions A, B such that all the shapes with Pathology A are inside a region A and all the shapes with Pathology B are inside region B. We can also define a region N that contains the rest of the shapes that should not be identified in the images, as they are not present in the training set 426.

Once the search of the AAM model is complete on a specific image 418, the parameters C which has been found in the location of the model can be used to determine the type of pathology of the patient, based on the partition of the plane R2. Note that if the search identifies a parameter C located in the region N, this can be used as an indication that the search was not successful. It is noted that this approach of labelling model parameters can be extended by using such as but not limited to rotation and scale parameters. In such case we would consider the vector (C, scale, rotation) instead of the vector C, and would partition and label this space accordingly.

AAM Interpolation

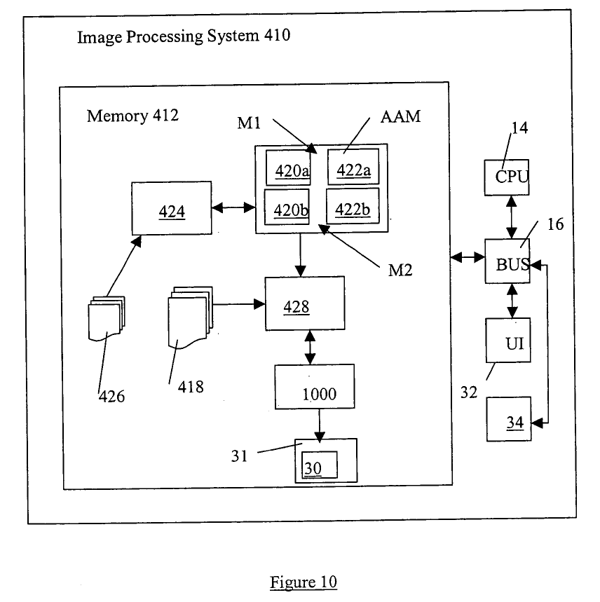

Referring to FIG. 10, like elements have similar reference numerals and description to those elements given in FIG. 4. The system 410 also has an interpolation module 1000 for interpolating over position and/or time replacement output object(s) for erroneous output object(s) 30, the interpolation based on the adjacent output objects 30 on either side of the erroneous output objects 30, as further described below. It is recognised that the AAM interpolation deals with an optimization of the AAM model usage when the objective can be to segment a set of images 418 with the same model Mi.

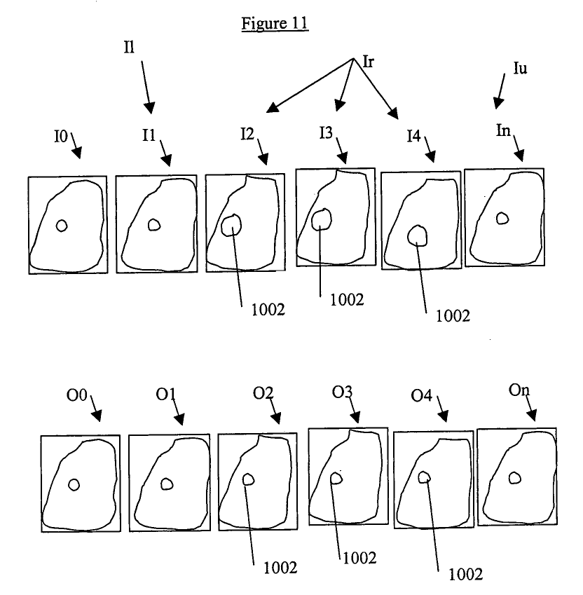

The images 418 can have the same anatomy imaged over time or at different locations. In this case the images 418 are parallel to one another when analysed by the search module 428. The images 418 are ordered along acquisition time or location, which can be indicated as I0 . . . In (see FIG. 11a). It is noted that what is described is typically used for cross-sectional 2D images 418 (such as CT and MR images), however it is still applicable for other images 418, such as but not limited to fluoroscopic images 418.

It is a known fact from the literature that searching a model object M in the image 418 is an optimisation process in which the difference between the model object image (output object 30) and the target object 200 in the image 418 is minimized by changing the following parameters, such as but not limited to:
1. Position of the model object Mi inside the image 418;
2. Scale (or Size) of the model object Mi;
3. Rotation of the model object Mi; and
4. Model parameters C (also called Combined Score), which is the vector which is used to generate the shape and texture values.
   In a real application, it is recognised that the search module 428 in applying the model object Mi to multiple adjacent object output images Ii (see FIG. 11a) that some solution could be generated for selected ones of the output objects Ii which is not optimal in the sense that:
The algorithm identifies a local minima instead of the global minima; and
The segmentation of the target object 200 typically has spatial/temporal continuity, which might not be properly represented in the segmentation obtained due to the presence of small errors.

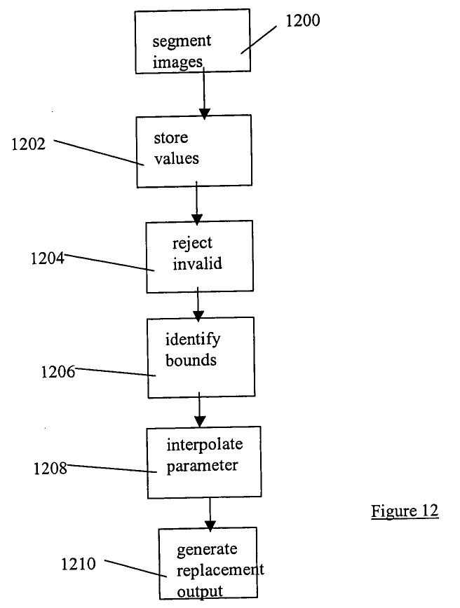

Referring again to FIG. 11a, it can be noted that the output objects 12, 13, and 14 have an erroneously large feature 1002 as compared to adjacent output objects I1 and In, with the feature 1002 in 14 being in the wrong positional as well. The interpolation module 1000 (see FIG. 10) is used to help improve the segmentation of the output objects I0 . . . In by removing the local minima and enhancing the temporal/spatial continuity of the solutions to provide the corrected output objects O0 . . . On as seen in FIG. 11b. The steps (referring to FIG. 12) of the algorithm implemented by the interpolation module 1000 are as follows:
1. All the images 418 are segmented 1200 in an image sequence (temproal and/or spatial) by the search module 428 using the selected model object M to produce the initial output objects I0 . . . In. For each initial output object the following original values are stored 1202, such as but not limited to,
   a. Position of the output object,
   b. Size of the output object,
   c. Rotation of the output object,
   d. converged Model Parameters assigned to the output object, and
   e. Error Between output object and target object in the image 418 (several error measures can be used including the Average Error).
2. In the example shown in FIG. 11a, we reject 1204 some segmentations based on:
   a. The error is greater then a specific threshold, and/or
   b. One or more of the output object parameters is not within a specific tolerance when compared to the average, or is too far from the minimal square line (used if there is the assumption that that parameter has to change in a predefined relationship—e.g. linearly).
3. Assuming that at least two segmentations has not been rejected, in order provide output object 30 examples from which to perform the linear interpolation, the segmentation on each of the rejected output objects Ir can be computed as follow. For each rejected segmentation on Ir (in this case I2, I3, I4)
   a. Identify 1206 two adjacent output objects I1 and Iu (in this case I1 and I5) with 0<1<r<u<n such that (it is recognised that other examples are I1=I0 and Iu=In):
      The segmentation on output objects I1 and Iu are not rejected and
      All the segmentation of the images between Ir and I1 and Ir and Iu have been rejected.
   If it is not possible to determine 1 and u with these characteristic then the segmentation for Ir can not be improved.
   b. The model parameters C, position, size and location and angle between those for U1 and Iu are interpolated 1208 using a defined interpolation relationship (such as but not limited to linear) in order to generate 1210 the replacement model parameters for use as input parameters for the output objects Ir.
   c. The search module 428 is then used to reapply the model object Mi using the interpolated replacement model parameters to generate corresponding new segmentations O2, O3, O4 as shown in FIG. 11b.
   d. The solution determined in the previous step can be optimized further running a few steps of the normal AAM (see in Cootes presentation “Iterative Model Refinement” slide or in Stagmann presentation “Dynamic of simple AAM” slide).

Referring to FIGS. 11a and 11b, in the first row the segmentation is carried out on each slice, independently. In the three middle slices the segmentation failed and chose a local minima, these segmentations are then rejected because the error is greater than the selected threshold. The interpolation module is able to recover the segmentation of these slices, as shown in the bottom row, using the interpolation algorithm as given above.

It will be appreciated that the above description relates to preferred embodiments by way of example only. Many variations on the system 10, 410 will be obvious to those knowledgeable in the field, and such obvious variations are within the scope of the invention as described and claimed herein, whether or not expressly described. Further, it is recognised that the target object 200, model object (420, 422), output object 30, image(s) 418, and training images 426 and training objects 201 can be represented as multidimensional elements, including such as but not limited to 2D, 3D, and combined spatial and/or temporal sequences.

1. An image processing system having a statistical appearance model for interpreting a digital image, the appearance model having at least one model parameter, the system comprising:
a multi-dimensional first model object including an associated first statistical relationship and configured for deforming to approximate a shape and texture of a multi-dimensional target object in the digital image, and a multi-dimensional second model object including an associated second statistical relationship and configured for deforming to approximate the shape and texture of the target object in the digital image, the second model object having a shape and texture configuration different from the first model object;
a search module for applying the first model object to the image for generating a multi-dimensional first output object approximating the shape and texture of the target object and calculating a first error between the first output object and the target object, and for applying the second model object to the image for generating a multi-dimensional second output object approximating the shape and texture of the target object and calculating a second error between the second output object and the target object;
a selection module for comparing the first error with the second error such that one of the output objects with the least significant error is selected; and
an output module for providing data representing the selected output object to an output.

2. The system according to claim 1; wherein the first model object is optimised for identifying a first one of the target object and the second model object is optimised for identifying a second one of the target object, such that the second target object having an shape and texture configuration different from the first target object.

3. The system according to claim 2 further comprising the digital image being one of a set of digital images, wherein each of the model objects are configured for being applied by the search module to each of the digital images of the set.

4. The system according to claim 3 further comprising the selection module configured for selecting one of the object models to represent all the images in the set.

5. The system according to claim 1; wherein the output is selected from the group comprising an output file for storage in a memory and a user interface.

6. The system according to claim 2 further comprising a training module configured for having a set of training images including a plurality of training objects with different appearance configurations, the training module for training the appearance model to have a plurality of the model objects optimised for identifying valid ranges of the shape and texture of respective ones of the target object.

7. The system according to claim 2, wherein the appearance model is an active appearance model.

8. The system according to claim 2, wherein the first and second model objects represent different pathology types of patient anatomy.

9. The system according to claim 2, wherein the first and second model objects represent different appearance configurations of the same anatomy of two different two dimensional slices taken from spaced apart locations of an image volume of the anatomy.

10. The system according to claim 8, wherein the two different pathology types represented by two different training objects in a set of training images.

11. The system according to claim 1 further comprising a predefined characteristic associated with the model parameter of the selected model object, the predefined characteristic for aiding a diagnosis of a patient having an anatomy represented by the selected output object.

12. The system according to claim 11, wherein the model parameter is partitioned in to a plurality of value regions, each of the regions assigned one of a plurality of the predefined characteristics.

13. The system according to claim 12, wherein the model parameter is selected from the group comprising a shape and texture parameter, a scale parameter and a rotation parameter.

14. The system according to claim 12, wherein at least two of the predefined characteristics represent different pathology types of the anatomy.

15. The system according to claim 12, wherein the output module provides to the output the predefined characteristic assigned to the selected output object.

16. The system according to claim 12 further comprising a training module configured for assigning the plurality of the predefined characteristics to the model parameter.

17. The system according to claim 15 further comprising a confirmation module for determining if the value of the model parameter assigned to the selected output object is within one of the partitioned regions.

18. The system according to claim 17, wherein the value of the model parameter when outside of all the partitioned value regions indicates the first output object is an invalid approximation of the target object.

19. An image processing system having a statistical appearance model for interpreting a sequence of digital images, the appearance model having at least one model parameter, the system comprising:
a multi-dimensional model object including an associated statistical relationship, the model object configured for deforming to approximate a shape and texture of multi-dimensional target objects in the digital images;
a search module for selecting and applying the model object to the images for generating a corresponding sequence of multi-dimensional output objects approximating the shape and texture of the target objects, the search module calculating an error between each of the output objects and the target objects;
an interpolation module for recognising at least one invalid output object in the sequence of output objects, based on an expected predefined variation between adjacent ones of the output objects of the sequence, the invalid output object having an original model parameter; and
an output module for providing data representing the sequence of output objects to an output.

20. The system according to claim 19 further comprising an interpolation algorithm of the interpolation module for calculating an interpolated model parameter from a pair of adjacently bounding output objects of the sequence, the pair located on either side of the invalid output object, the interpolated model parameter for replacing the original model parameter.

21. The system according to claim 20, wherein the interpolated model parameter is selected from the group comprising position, scale, rotation, and shape and texture.

22. The system according to claim 20, wherein determination of the invalid output object is based on the original model parameter being outside of a predefined parameter threshold.

22. The system according to claim 20, wherein determination of the invalid output object is based on the first error being outside of a predefined error threshold.

23. The system according to claim 20, wherein there is a plurality of adjacent invalid output objects.

24. The system according to claim 20, wherein the interpolation of the interpolation algorithm is based on a predefined interpolation relationship based on a magnitude of separation between the pair of bounding output objects and the invalid ourput object in the sequence.

25. The system according to claim 20, wherein the search module reapplies the first model object to the images using the interpolated model parameter as input in order to generate a new output object to replace the invalid output object in the sequence.

26. The system according to claim 19, wherein the sequence is selected from the group comprising temporal and spatial.

27. A method for interpreting a digital image with a statistical appearance model, the appearance model having at least one model parameter, the method comprising the steps of:
providing a multi-dimensional first model object including an associated first statistical relationship and configured for deforming to approximate a shape and texture of a multi-dimensional target object in the digital image;
providing a multi-dimensional second model object including an associated second statistical relationship and configured for deforming to approximate the shape and texture of the target object in the digital image, the second model object having a shape and texture configuration different from the first model object;
applying the first model object to the image for generating a multi-dimensional first output object approximating the shape and texture of the target object;
calculating a first error between the first output object and the target object;
applying the second model object to the image for generating a multi-dimensional second output object approximating the shape and texture of the target object;
calculating a second error between the second output object and the target object;
comparing the first error with the second error such that one of the output objects with the least significant error is selected; and
providing data representing the selected output object to an output.

28. A computer program product for interpreting a digital image using a statistical appearance model, the appearance model having at least one model parameter, the computer program product comprising:
a computer readable medium;
an object module stored on the computer readable medium configured for having a multi-dimensional first model object including an associated first statistical relationship and configured for deforming to approximate a shape and texture of a multi-dimensional target object in the digital image, and a multi-dimensional second model object including an associated second statistical relationship and configured for deforming to approximate the shape and texture of the target object in the digital image;
a search module stored on the computer readable medium for applying the first model object to the image for generating a multi-dimensional first output object approximating the shape and texture of the target object and calculating a first error between the first output object and the target object, and for applying the second model object to the image for generating a multi-dimensional second output object approximating the shape and texture of the target object and calculating a second error between the second output object and the target object, the second model object having a shape and texture configuration different from the first model object;
a selection module coupled to the search module for comparing the first error with the second error such that one of the output objects with the least significant error is selected; and
an output module coupled to the selection module for providing data representing the selected output object to an output.

29. A method for interpreting a digital image with a statistical appearance model, the appearance model having at least one model parameter, the method comprising the steps of:
providing a multi-dimensional model object including an associated statistical relationship, the model object configured for deforming to approximate a shape and texture of multi-dimensional target objects in the digital images;
applying the model object to the images for generating a corresponding sequence of multi-dimensional output objects approximating the shape and texture of the target objects;
calculating an error between each of the output objects and the target objects; and
recognising at least one invalid output object in the sequence of output objects, based on an expected predefined variation between adjacent ones of the output objects of the sequence, the invalid output object having an original model parameter; and
providing data representing the sequence of output objects to an output.
